(19) United States
(12) Patent Application Publication
(10) Pub. No.: US 2021/0018120 A1
(43) Pub. Date: Jan. 21, 2021

(54) COMPRESSION-TYPE FITTING FOR CONNECTING PIPES TO HYDRAULIC OR PNEUMATIC COMPONENTS OR FOR CONNECTING PIPES TOGETHER, PARTICULARLY FOR REFRIGERATION SYSTEMS

(71) Applicant: OLAB S.R.L., Torbole Casaglia (IT)

(72) Inventor: Cesare BOTTURA, Brescia (IT)

(73) Assignee: OLAB S.R.L., Torbole Casaglia (IT)

(21) Appl. No.: 16/516,389

(22) Filed: Jul. 19, 2019

(51) Int. Cl. F16L 13/14

(52) U.S. Cl. CPC F16L 13/146

(57) ABSTRACT

A compression-type fitting for connecting pipes to hydraulic or pneumatic components or for connecting pipes together, particularly for refrigeration systems, comprising a fitting body provided with a male thread adapted to be engaged by a female thread of a locking nut, an ogive being interposed between the locking nut and the fitting body, a sealing gasket being provided between the ogive and the fitting body, the ogive being adapted to adhere to the external surface of a pipe to be connected; the locking nut has an internal taper such as to deform, during the tightening action, the ogive and produce a constriction thereof on the pipe to be connected.

The present invention relates to a compression-type fitting for connecting pipes to hydraulic or pneumatic components or for connecting pipes together, particularly for refrigeration systems.

A type of fitting known as compression-type fitting is often used in the field of hydraulic and/or pneumatic systems. This type of fitting allows to connect pipes to hydraulic or pneumatic components of various kinds, such as for example electric valves, ball valves, cocks, safety valves, or to connect pipes together, thanks to the deformation of the end of an ogive-shaped sleeve that is inserted inside it.

More particularly, this type of fitting is generally constituted by a fitting body in which there is, starting from one of its ends, at least one substantially cylindrical seat which is open outward and is adapted to receive coaxially an end portion of a pipe. The end of the fitting body, around the access opening of this seat, is threaded and can be coupled to a locking nut, which is crossed axially by a passage for the pipe to be connected. The fitting is completed by a sleeve, known indeed as ogive, which can be fitted around the end portion of the pipe and has an axial end that can be deformed toward the axis of the seat so as to engage the external surface of the end portion of the pipe. The ogive is interposed between the locking nut and a conical resting region which is formed in the fitting body. The locking nut can be tightened along the threaded portion in order to produce the deformation of the axial end of the ogive, which partially penetrates the pipe to be connected, producing an incision in its lateral surface.

The ogive, due to the incision that it produces on the pipe, performs the dual function of ensuring the pressure tightness of the fitting and of locking the pipe, preventing its extraction from said fitting.

The localized compression between the ogive and the pipe is in fact so high that fluids struggle to seep toward the outside of the fitting and furthermore the pipe cannot slide out.

This solution, used until now, has however a potential drawback. If the pipes are provided with grooves and/or hollows on their external surface, the incision produced by the deformation of the ogive might not be sufficient to prevent the seepage of pressurized fluid outside the fitting.

This drawback is furthermore amplified if the fittings must be used in refrigeration systems. In this case, in fact, the molecules of the gases used are very small and therefore seepage can be considerable. Since refrigeration systems are of the closed-circuit type, even a small leak of gas over time causes the progressive emptying of the system, which begins losing efficiency to the point of making it necessary to anticipate the operation for refilling gas in the system.

In order to overcome this problem, two types of connection are used in the refrigeration systems currently in use:
SAE FLARE connection;
connection by welding.

The first type of connection assumes that the end of the pipe to be connected undergoes a particular shaping operation known as flaring. This operation consists in shaping the end of the pipe to be connected, which after this operation has a 45° flared region and the seal of the connection is achieved by means of the compression of the flared pipe portion between the end of a compression-type male fitting, with a taper that is complementary to that of the flared region, and a receptacle which achieves engagement by means of a thread on said male fitting.

The male fitting engaged by the receptacle, can also be provided at the inlet or outlet of components such as electric valves, ball valves or safety valves, thus allowing the connection of these components with the pipes.

The second type of connection is performed by means of an operation for welding the pipe, which is usually made of copper.

Welding entails the presence of an appropriate seat, termed weld-in pocket, in which the copper pipe that must be connected is inserted and then welded.

The weld-in pocket can be provided on elements such as fittings, electric valves, ball valves, etc.

Both of these kinds of connection, used particularly for refrigeration systems as a replacement of compression-type fittings, have disadvantages which can cause some potential problems that are a consequence of their use.

In the case of connections of the SAE FLARE type, it is necessary to flare the pipe before being able to connect the pipe, and this operation must be performed correctly in order to avoid leaks of the fitting. Furthermore, it is necessary to use pipes that have internal and external surfaces that have no grooves, since the compression of the pipe between the male fitting and the receptacle might not be sufficient to ensure the tightness of the connection. Finally, it is always necessary to screw on the receptacle with a high tightening torque in order to be able to provide the dry seal between the male fitting, the pipe and the receptacle.

In the case of connections by welding, the operation for welding the two elements, for example between an electric valve and a pipe, produces an addition of heat which propagates through the elements that must be welded. This can damage some components, such as the sealing gaskets that are present inside said elements. Usually, in order to avoid this problem, assembly workers place wet rags on the element to be protected and perform the welding by stopping periodically in order to limit heat propagation.

Furthermore, the components assembled by pipe welding cannot be replaced except by cutting the pipes. Therefore, if one wishes to replace an electric valve it is necessary to cut the connecting pipe and insert another electric valve and then perform the connecting weld again.

A further drawback is constituted by the fact that components such as electric valves must be provided to assembly workers without the coil, since during the welding operation the solenoid might be damaged. This entails an expenditure of time to assemble the coil to the body of the electric valve at a later time.

One drawback that is common to these two types of connection, which are alternative to the use of compression-type fittings, is constituted by the fact that in order to be performed they require the intervention of specialized personnel.

One solution to the drawbacks noted above entails providing a compression-type fitting for connecting pipes to hydraulic or pneumatic components or for connecting pipes together, which comprises a body and a fitting in which there is, starting from one of its ends, at least one substantially cylindrical seat, which is open outward and is adapted to receive partially an end portion of a pipe. A locking nut can be coupled to a threaded portion surrounded by openings for access to the seat and crossed axially by a passage for the pipe.

A sleeve or ogive can be fitted around the end portion of the pipe. The ogive has an axial end that can be deformed toward the axis of the seat in order to engage the external surface of the end portion of the pipe inserted in the seat. The ogive can be interposed between the locking nut and a resting region that is formed by the fitting body and the locking nut can be fastened along the threaded portion in order to deform the axial end of the ogive.

There is also a sealing gasket, which is elastically deformable, that can be fitted around the end portion of the pipe and can be positioned between the axial end of the ogive that is opposite with respect to the deformable axial end and an abutment formed in the fitting body. The sealing gasket can be compressed axially for its constriction around the end portion of the pipe, following the tightening of the locking nut along the threaded portion of the fitting body.

Furthermore, there is a reinforcement bushing which can be inserted in the end portion of the pipe.

The connection system provides for the use of an ogive which is appropriately shaped for the closure thereof on the pipe to be connected, of a sealing gasket and of a reinforcement bushing which is inserted in the inside diameter of the pipe.

The device (fitting, electric valve, ball valve, cock, safety valve, etc.) that must be connected to the pipe has a male threaded end which can engage a threaded nut.

At the end of the male thread there is an appropriate groove for accommodating the O-ring, which is the sealing element of said fitting.

A contoured ogive is arranged between the end of the fitting and the nut that engages the thread of said body and has two functions: compressing the O-ring in its seat, so that it can provide the pressure seal with the pipe and coin itself with respect to the pipe in order to avoid its extraction under pressure.

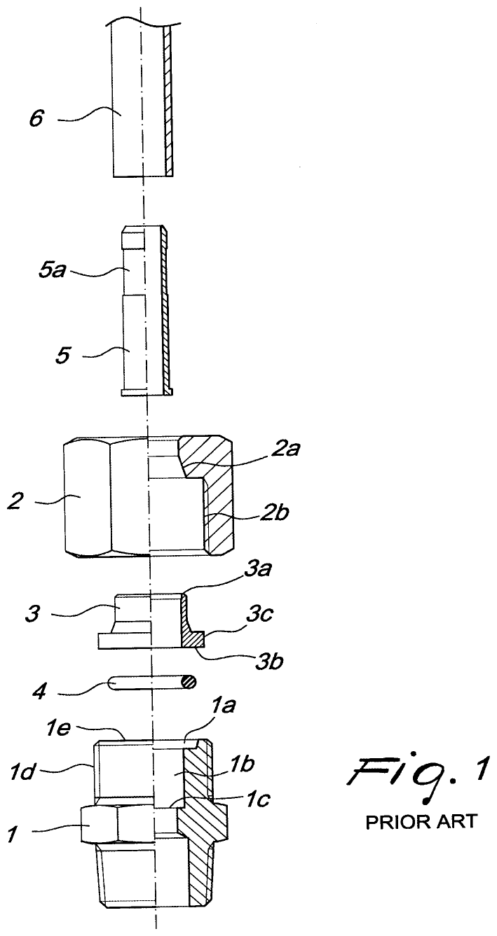

In detail, with reference to FIG. 1, the fitting is composed of:

a body 1, which has a male threaded end 1d which can be engaged by a nut 2 by means of its female thread 2b. The fitting body has, on the same side of the thread, also a seat 1b for the accommodation of the pipe 6 to be connected and a seat 1a for the accommodation of the sealing O-ring 4;

an appropriately shaped ogive 3 has on one side a flat surface 3b, which can engage, deforming the O-ring 4, until abutment occurs against the end 1e of the fitting body. The same ogive has an outside diameter 3c such that it can be inserted in the nut 2 until it engages its end 3a on the conical surface 2a that is present inside said nut;

a reinforcement bushing 5, such that it can be inserted within the pipe 6, penetrating it until its abutment 5b engages the end of said pipe 6a. Once it has been positioned in the pipe, the bushing has a region with a reduced diameter 5a which is arranged with its central part at the active region of the ogive 3.

The assembly sequence according to the invention for the connection of the pipe is as follows.

The nuts 2, the ogive 3, the O-ring 4 are fitted in sequence on the pipe to be connected 6 and the reinforcement bushing 5 is inserted therein.

The end of the pipe is inserted in the seat 1b that is present on the fitting body 1 and the nut 2 is screwed by means of its thread 2b on the fitting body until the upper top of the ogive 3a rests against the taper 2a that is present inside said nut.

At this point the fitting is assembled and ready for the step for tightening the nut, which produces the pressure seal and the locking of the pipe.

During this step the cone 3, under the effect of the tightening of the nut 2, is pushed toward the fitting body 1, compressing the O-ring 4 in its seat 1a.

The compression of the O-ring proceeds until the surface 3b of the ogive makes contact with the upper end le of the fitting body.

At this point, as an effect of this deformation of the O-ring, the pressure seal between the fitting and the pipe to be connected has already been created and the pipe locking step begins.

In fact, by continuing to tighten the nut, the ogive which is in abutment against the body and therefore cannot move, begins to deform and its upper end 3a, by entering the tapering portion 2a that is present inside the nut, is closed inward until it deforms and produces an incision in the external surface of the pipe.

The deformation of the pipe triggered by the action of the ogive creates a bend of the internal and external surfaces of said pipe and the internal surface enters the recessed region 5a of the reinforcement bushing until it engages the bottom of the outlet of said bushing.

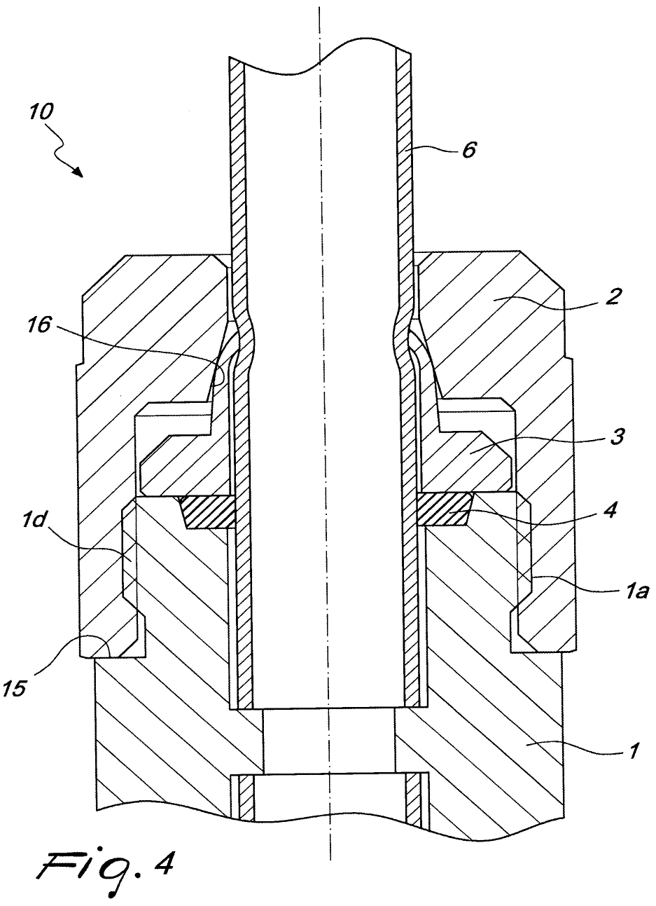

This deformation, added to the fact that the ogive has produced an incision in the pipe and therefore has locked it, contributes to the extraction—preventing action of the pipe, since as can be seen from the detail of FIG. 4 the edges of the recess 5a engage with deformation of the pipe, producing for it steps that retain it in position.

The reinforcement bushing, useful to increase the retention pressure of the pipe in the fitting, in some cases is difficult to be used for the following reasons:
The useful passage section of the pipe decreases. This can be a problem when pipes with a small diameter and which therefore already have a small internal passage hole are used.
The thickness of the pipe is nonstandard. In this case, since the bushings are designed for specific pipe thicknesses, their insertion in the pipe might be impossible or vice versa the bushing might have too much playing inside the pipe.
The pipe has an ovalized internal hole and therefore the bushing cannot be inserted in the pipe.

In these cases, the fitting can be used even without the internal bushing. Of course, in the absence of this component, the operating pressures decrease and this reduction of the maximum operating pressure becomes greater as the diameter of the pipe used increases.

On pipes having a small diameter (by way of indication, up to pipes having an outside diameter of ½″), since the operating pressure of the standard fitting is very high, using the bushing or not does not entail significant variations for the end user.

However, the use of the fitting without the bushing has a drawback during assembly. With particularly soft copper pipes, the ogive in fact does not find contrast inside the pipe (usually determined by the stainless steel reinforcement bushing) and therefore even with relatively low nut locking torques the pipe undergoes a considerable incision and sometimes to the limit of its failure (the ogive penetrates the inside diameter).

The aim of the present invention is to provide a compression-type fitting for connecting pipes to hydraulic or pneumatic components or for connecting pipes together, which can be used without a bushing, overcoming the drawbacks noted in the background art.

Within this aim, an object of the present invention is to provide a compression-type fitting that has a “controlled” ogive constriction.

Another object of the present invention is to provide a compression-type fitting in which the inside diameter of the ogive, for each pipe reference, is calibrated to a given closure and cannot exceed this value, to prevent the pipe from being potentially cut by the ogive.

Another object of the present invention is to provide a compression-type fitting that is highly reliable, relatively simple to provide and at competitive costs.

This aim, as well as these and other objects which will become better apparent hereinafter, are achieved by a compression-type fitting for connecting pipes to hydraulic or pneumatic components or for connecting pipes together, particularly for refrigeration systems, comprising a fitting body provided with a male thread adapted to be engaged by a female thread of a locking nut, an ogive being interposed between said locking nut and the fitting body, a sealing gasket being provided between said ogive and said fitting body, said ogive being adapted to adhere to the external surface of a pipe to be connected, characterized in that said locking nut has an internal taper such as to deform, during the tightening action, said ogive and produce a constriction thereof on the pipe to be connected.

Further characteristics and advantages of the invention will become better apparent from the description of a preferred but not exclusive embodiment of the compression-type fitting according to the invention, illustrated by way of non limiting example in the accompanying drawings, wherein:

FIG. 1 is an exploded view of a compression-type fitting of the known type;

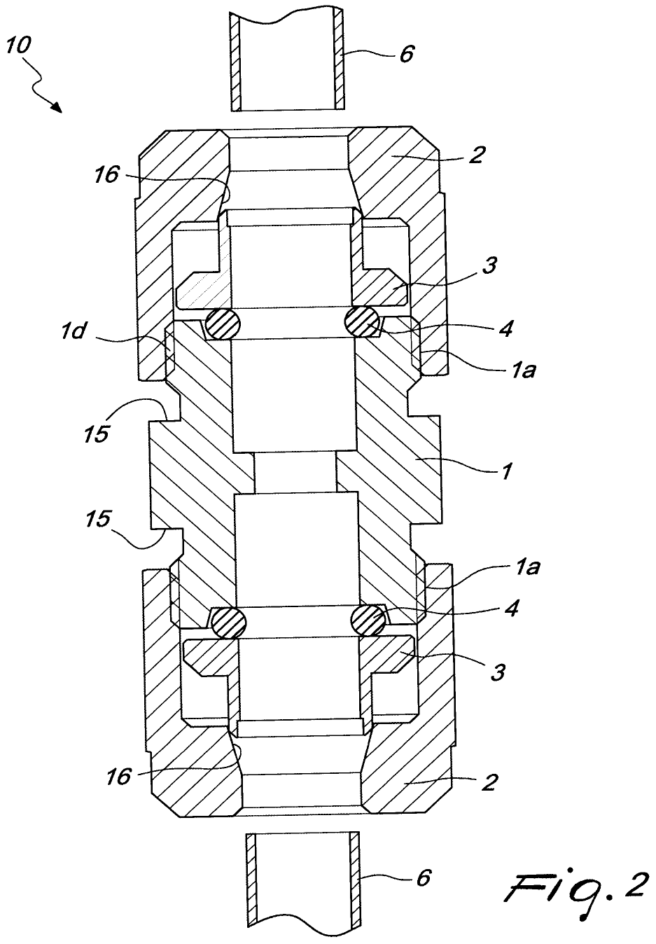

FIG. 2 is a longitudinal sectional view of the compression-type fitting according to the present invention;

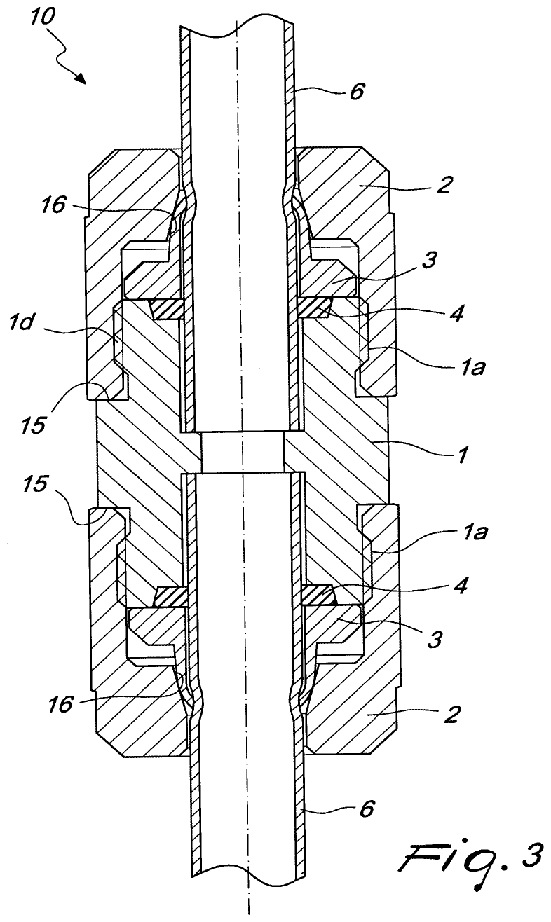

FIG. 3 is a longitudinal sectional view of the compression-type fitting according to the present invention in the condition for connecting two pipes;

FIG. 4 is a partial longitudinal sectional view of a detail of the compression-type fitting according to the present invention.

With reference to the figures, the compression-type fitting according to the invention, designated generally by the reference numeral 10, comprises a fitting body 1 which has a male threaded end la with which a locking nut 2 engages by means of a female thread thereof.

The fitting body 1 has, on the same side as the thread, a seat for the accommodation of a pipe 6 to be connected and a seat for a sealing gasket 4.

The male thread 1d of the fitting body 1 has a threaded portion that is shorter than fittings of the standard type. As mentioned, the nut screws onto the thread portion and, once tightening is complete, the nut stops against a mechanical abutment 15 formed on the body 1 of the fitting.

In the case of straight parts, the abutment is a hexagonal key that is present at the center of the fitting body.

Conveniently, the nut 2 is contoured internally with a taper 16 and the locking of the nut produces, as a consequence of this internal taper, the constriction of an ogive 3 that is accommodated in contact with the body 1 of the fitting, thus compressing the gasket 4, and is adjacent to the pipe 6 to be connected.

The constriction of the ogive 3 therefore occurs by means of the nut 2 against the pipe to be connected.

The constriction of the ogive, for each pipe reference, is always the same, i.e., the inside diameter of the ogive at the end of the tightening is always constant.

The controlled constriction of the ogive diameter allows to retain the pressurized pipe inside the fitting without however damaging the pipe itself, which is therefore assembled without a reinforcement bushing.

The pressure seal is assigned, as in the background art, to the O-ring gasket 4.

In practice it has been found that the compression-type fitting according to the invention achieves the intended aim and objects, since it allows to avoid the internal bushing, and this therefore does not cause a reduction of the flow rate of the fitting.

Furthermore, the operating pressures are lower than a fitting complete with a reinforcement bushing, since said fitting is applied to small-diameter pipes, and in any case higher levels than those usually provided for fittings of the known type are maintained.

Furthermore, it is to be noted the absence of a reinforcement bushing as well as the difficulty of inserting it inside the pipe. The difficulties that can occur in the case of pipes with an ovalized or nonstandard inside diameter are therefore overcome.

The fitting thus conceived is susceptible of numerous modifications and variations, all of which are within the scope of the appended claims.

All the details may furthermore be replaced with other technically equivalent elements.

In practice, the materials used, as well as the contingent shapes and dimensions, may be any according to the requirements and the state of the art.

What is claimed is:

1. A compression-type fitting for connecting pipes to hydraulic or pneumatic components or for connecting pipes together, particularly for refrigeration systems, comprising a fitting body provided with a male thread adapted to be engaged by a female thread of a locking nut, an ogive being interposed between said locking nut and the fitting body, a sealing gasket being provided between said ogive and said fitting body, said ogive being adapted to adhere to the external surface of a pipe to be connected, wherein said locking nut has an internal taper such as to deform, during the tightening action, said ogive and produce a constriction thereof on the pipe to be connected.

2. The compression-type fitting according to claim 1, wherein said locking nut deforms, as a consequence of the screwing onto said body, the end of said ogive that adheres to said pipe to be connected, deforming it.

3. The compression-type fitting according to claim 1, wherein said locking nut, once tightening has occurred, locks against a mechanical abutment formed at the body of said fitting.

4. The compression-type fitting according to claim 1, wherein at the end of the tightening process the inside diameter of said ogive, when pressure of the locking nut is applied thereto, is always constant.
